(19) United States
(12) Patent Application Publication
(10) Pub. No.: US 2026/0254723 A1
(43) Pub. Date: Aug. 27, 2026

(54) ENHANCED PACKET PROCESSING IN A CLOUD PLATFORM TO SUPPORT TIME-SENSITIVE COMMUNICATION FOR REAL-TIME VIRTUALIZED APPLICATIONS OVER A TIME-SENSITIVE NETWORK THAT IS INTEGRATED WITH A MOBILE NETWORK

(71) Applicant: TELEFONAKTIEBOLAGET LM ERICSSON (PUBL), Stockholm (SE)

(72) Inventors: Dhruvin Patel, AACHEN (DE); János Harmatos, Budapest (HU); Milad Ganjalizadeh, STOCKHOLM (SE)

(21) Appl. No.: 19/160,127

(22) PCT Filed: Feb. 27, 2023
(86) PCT No.: PCT/IB2023/051825

§ 371 Date: Aug. 27, 2025

(51) Int. Cl. H04L 41/0895; H04L 41/5041; H04L 47/28; H04L 49/00

(52) U.S. Cl. CPC H04L 41/0895; H04L 41/5041; H04L 47/28; H04L 49/70

(57) ABSTRACT

A method performed by one or more network devices is disclosed for configuring a virtual switch implemented in a cloud platform. The method includes obtaining traffic characteristics information for one or more time-sensitive data streams that are to traverse a mobile network acting as a virtual bridge of a time-sensitive network, wherein components of the mobile network are implemented in the cloud platform, obtaining tunnel identifiers of tunnels in the mobile network that are to carry the one or more time-sensitive data streams, obtaining application deployment information for an application that communicates with end devices connected to the time-sensitive network, wherein components of the application are implemented in the cloud platform, generating configuration information for the virtual switch based on the tunnel identifiers, the traffic characteristics information, and the application deployment information, and causing the virtual switch to be configured based on the configuration information.

### TECHNICAL FIELD

Embodiments of the invention relate to the field of communication networks, and more specifically, to enhanced packet processing in a cloud platform to support time-sensitive communication over a time-sensitive network that is integrated with a mobile network.

### BACKGROUND

Private networks or campus networks can be used by manufacturing industries to support a wide range of use cases over a single communication infrastructure. Private networks typically cover a limited geographical area and are used to support applications that have various quality of service (QoS) requirements. Fifth Generation (5G) mobile networks have desirable features such as low latency and high reliability that allow them to be used for implementing private networks that can support applications with strict QoS requirements.

Third Generation Partnership Project (3GPP) is working towards supporting Time-sensitive Networking (TSN) features in 5G mobile networks. TSN describes a collection of features (e.g., time synchronization, guaranteed low latency transmissions, and high reliability) to make legacy Ethernet, which is designed for best-effort communication, predictable and hence deterministic. TSN is based on the IEEE 802.1 Ethernet standard, which is used for wired communication, whereas 5G is mainly used for wireless radio communication, e.g., using Long Term Evolution (LTE) and/or 5G New Radio (NR). A TSN network can be integrated with a private 5G mobile network to provide wireless connectivity. For example, a TSN network can be integrated with a private 5G mobile network such that the private 5G mobile network acts as a virtual/logical bridge of the TSN network. The private 5G mobile network may include TSN translators that allow it to interoperate with the TSN network.

For ease of maintenance and/or cost saving purposes, some components of the private 5G mobile network core such as the user plane functions (UPFs) may be implemented as virtual network functions in a cloud platform (i.e., the UPFs may be virtualized). Several virtual network functions may be hosted on one or more than one physical computing device (e.g., a server blade). The cloud platform may also be used to implement an application that communicates with end devices connected to the TSN network (e.g., the application may control factory robots from the cloud). Following cloud-native design principles, the application may be decomposed into multiple containerized components in the cloud platform, which provides the benefit of being able to develop, deploy, and manage the application components independently.

In a private network deployment for an industry/factory use case, a single cloud platform may need to support various types of network traffic such as enhanced mobile broadband (eMBB) network traffic, critical machine type communication (c-MTC) network traffic, massive machine type communication (m-MTC) network traffic, as well as network traffic between the containerized components of industry control application(s). A virtual switch implemented in the cloud platform could be used to process network traffic between the radio access network (RAN) of the 5G mobile network and the virtualized components of the 5G mobile network core, as well as the network traffic between the application components implemented in the cloud platform. Currently, however, the virtual switch is unable to differentiate between best-effort network traffic and time-sensitive network traffic (e.g., TSN data streams). Thus, the virtual switch is not able to prioritize the processing of time-sensitive network traffic over best-effort network traffic or reserve resources for the processing of time-sensitive network traffic. As a result, packet processing latency for time-sensitive network traffic at the virtual switch, which is a key contributor to the overall end-to-end (E2E) latency, cannot be bounded with the current configuration. Thus, the virtual switch is a potential bottleneck for processing network traffic in the cloud platform.

### SUMMARY

A method performed by one or more network devices is disclosed for configuring a virtual switch implemented in a cloud platform. The method includes obtaining traffic characteristics information for one or more time-sensitive data streams that are to traverse a mobile network acting as a virtual bridge of a time-sensitive network, wherein one or more components of the mobile network are implemented in the cloud platform, obtaining tunnel identifiers of tunnels in the mobile network that are to carry the one or more time-sensitive data streams, obtaining application deployment information for an application that communicates with end devices connected to the time-sensitive network, wherein one or more components of the application are implemented in the cloud platform, generating configuration information for the virtual switch based on the tunnel identifiers, the traffic characteristics information for the one or more time-sensitive data streams, and the application deployment information for the application, and causing the virtual switch to be configured based on the configuration information.

A non-transitory machine-readable storage medium is disclosed that provides instructions that, if executed by a processor of one or more network devices, will cause the one or more network devices to carry out operations for configuring a virtual switch implemented in a cloud platform. The operations include obtaining traffic characteristics information for one or more time-sensitive data streams that are to traverse a mobile network acting as a virtual bridge of a time-sensitive network, wherein one or more components of the mobile network are implemented in the cloud platform, obtaining tunnel identifiers of tunnels in the mobile network that are to carry the one or more time-sensitive data streams, obtaining application deployment information for an application that communicates with end devices connected to the time-sensitive network, wherein one or more components of the application are implemented in the cloud platform, generating configuration information for the virtual switch based on the tunnel identifiers, the traffic characteristics information for the one or more time-sensitive data streams, and the application deployment information for the application, and causing the virtual switch to be configured based on the configuration information.

A network device is disclosed that is configured to configure a virtual switch implemented in a cloud platform. The network device includes one or more processors and a non-transitory machine-readable storage medium storing instructions therein that when executed by the one or more processors causes the network device to obtain traffic characteristics information for one or more time-sensitive data streams that are to traverse a mobile network acting as a virtual bridge of a time-sensitive network, wherein one or more components of the mobile network are implemented in the cloud platform, obtain tunnel identifiers of tunnels in the mobile network that are to carry the one or more time-sensitive data streams, obtain application deployment information for an application that communicates with end devices connected to the time-sensitive network, wherein one or more components of the application are implemented in the cloud platform, generate configuration information for the virtual switch based on the tunnel identifiers, the traffic characteristics information for the one or more time-sensitive data streams, and the application deployment information for the application, and cause the virtual switch to be configured based on the configuration information.

A method performed by one or more network devices implementing a virtual switch in a cloud platform is disclosed. The method includes receiving, by the virtual switch, a packet traversing a mobile network implemented in the cloud platform and acting as a virtual bridge of a time-sensitive network, wherein the packet is part of a time-sensitive data stream, extracting, by the virtual switch, a tunnel identifier from a header of the packet, generating, by the virtual switch, a hash value based on the tunnel identifier, looking up, by the virtual switch, an entry in an indirection table using the hash value, wherein the entry indicates a mapping between the hash value and a particular processing core of the virtual switch, determining, by the virtual switch based on the entry, that the packet is to be processed by the particular processing core, and sending, by the virtual switch, the packet to a queue associated with the particular processing core.

A non-transitory machine-readable storage medium is disclosed that provides instructions that, if executed by one or more processors of one or more network devices, will cause the one or more network devices to carry out operations of a virtual switch implemented in a cloud platform. The operations include receiving, by the virtual switch, a packet traversing a mobile network implemented in the cloud platform and acting as a virtual bridge of a time-sensitive network, wherein the packet is part of a time-sensitive data stream, extracting, by the virtual switch, a tunnel identifier from a header of the packet, generating, by the virtual switch, a hash value based on the tunnel identifier, looking up, by the virtual switch, an entry in an indirection table using the hash value, wherein the entry indicates a mapping between the hash value and a particular processing core of the virtual switch, determining, by the virtual switch based on the entry, that the packet is to be processed by the particular processing core, and sending, by the virtual switch, the packet to a queue associated with the particular processing core.

A network device is disclosed that is configured to implement a virtual switch in a cloud platform. The network device includes one or more processors and a non-transitory machine-readable storage medium storing instructions therein that when executed by the one or more processors causes the network device to receive a packet traversing a mobile network implemented in the cloud platform and acting as a virtual bridge of a time-sensitive network, wherein the packet is part of a time-sensitive data stream, extract a tunnel identifier from a header of the packet, generate a hash value based on the tunnel identifier, look up an entry in an indirection table using the hash value, wherein the entry indicates a mapping between the hash value and a particular processing core of the virtual switch, determine, based on the entry, that the packet is to be processed by the particular processing core, and send the packet to a queue associated with the particular processing core.

### BRIEF DESCRIPTION OF THE DRAWINGS

The invention may best be understood by referring to the following description and accompanying drawings that are used to illustrate particular embodiments of the invention. In the drawings:

FIG. 1 is a diagram showing an environment that supports time-sensitive communication, according to some embodiments.

FIG. 2 is a diagram showing a switching instance manager configuring a virtual switch, according to some embodiments.

FIG. 3 is a flow diagram showing a method performed by a virtual switch to process a packet traversing a mobile network, according to some embodiments.

FIG. 4 is a diagram showing the use of an indirection table to process a packet, according to some embodiments.

FIG. 5 is a diagram showing component interactions to configure a virtual switch, according to some embodiments.

FIG. 6 is a flow diagram showing a method for configuring a virtual switch implemented in a cloud platform, according to some embodiments.

FIG. 7 shows an example of a communication system, according to some embodiments.

FIG. 8A shows connectivity between network devices (NDs) within an exemplary network, as well as three exemplary implementations of the NDs, according to some embodiments of the invention.

FIG. 8B shows an exemplary way to implement a special-purpose network device according to some embodiments of the invention.

### DETAILED DESCRIPTION

The following description describes methods and apparatus for configuring a virtual switch implemented in a cloud platform to support time-sensitive communication over a time-sensitive network that is integrated with a mobile network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

### Time-Sensitive Networking (TSN)

TSN is a set of standards under development by the Time-Sensitive Networking task group of the Institute of Electrical and Electronics Engineers (IEEE) 802.1 working group. TSN describes a collection of features (e.g., time synchronization, guaranteed low latency transmissions, and high reliability) to make legacy Ethernet, which is designed for best-effort communication, predictable and hence deterministic. Since TSN is based on the IEEE 802.1 Ethernet standard, it is for wired communication, whereas Fifth Generation (5G) is mainly for wireless radio communication using Long Term Evolution (LTE) and/or 5G New Radio (NR).

To enable predictable and very low latency communication (e.g., for industrial applications, where cycle time is known in advance), TSN provides a time-aware traffic scheduling feature (e.g., as described in IEEE 802.1Qbv-2015). A bridge or an end station may support enhancements that allow transmission from each queue to be scheduled relative to a known timescale. In order to achieve this, a transmission gate may be associated with each queue, where the state of the transmission gate determines whether or not queued frames can be selected for transmission. For a given queue, the transmission gate may be in an open state or a closed state. When a transmission gate is in the open state, queued frames are selected for transmission, in accordance with a transmission selection algorithm associated with the queue. When a transmission gate is in the closed state, queued frames are not selected for transmission. A gate control list may be used to control the state of the transmission gates at a specific point in time.

The transmission gate mechanism may be aware of time based on the use of a Precision Time Protocol (PTP) application within the bridge or end station. This allows for controlling and coordinating the transmission gate states across the TSN network to enable scheduled transmissions for a given class of traffic across the TSN network.

A central network configuration (CNC) entity of the TSN network may determine the schedule of the TSN data streams based on user requirements. The requirements may be provided by end devices (e.g., a talker and/or listener) or by a central user configuration (CUC) entity. The CUC may be an entity that communicates with the CNC and end devices. The CUC may submit requests for deterministic communication to the CNC with specific requirements. The CNC may use standard management objects (e.g., objects defined in IEEE 802.1Qcc) to configure transmission schedules for each TSN bridge via a remote network management protocol (e.g., during a TSN stream setup phase).

### Edge Computing

Edge computing is a computing paradigm where the cloud execution environment (e.g., which has computing and storage resources) is closer to the location where it is needed. The proximity of the edge cloud to the clients provides low latency communication between the server application implemented in the edge cloud and the clients. Edge computing may be useful for use cases that require ultra-low latency and high reliability. Edge computing plays an important role for supporting new or evolved time-critical Industry 4.0 use cases. Industry 4.0 refers to the rapid change to technology, industries, and societal patterns and processes due to increasing interconnectivity and smart automation. As an example, industrial control functionalities may be offloaded from end devices to the edge cloud, which allows for simpler end device design and the ability to execute more complex artificial intelligence (AI) and machine learning (ML) supported (closed-loop) control mechanisms (e.g., edge-enabled mobile robot control), as well as the ability to support the centralized control of collaborative devices.

The evolution of cloud technology allows the offloaded industrial control application to exploit the many benefits of the cloud. Instead of merely decoupling the monolith control application from the dedicated hardware and cloudifying it by moving it to the virtualized domain, the (monolith) application may be decomposed into multiple components. This allows the application components to be developed, deployed, and managed independently, according to cloud-native best practices and design principles.

Typically, the different components of a decomposed application are tightly coupled and need to communicate with each other. This means that if the application components are deployed in different containers, then the applications components have to use the container network (e.g., a virtual switch/bridge) to communicate with each other. In an industry control process, several closed control loops may exist between the controller application (deployed in the edge cloud) and the actuator. Thus, there is a strict time budget for the different application components to perform tasks, as well as for the communication between the applications components via the networking in the virtualized domain. The synchronization between the different component replicas is critical, which should also be considered in the communication between the components.

### Virtual Switch

The 5G mobile network architecture includes control plane components and data plane components. The control plane components may include UDM (unified data management), PCF (policy control function), NEF (network exposure function), NRF (network repository function), AMF (access management function), and SMF (session management function). The user plane components may include UE (user equipment), gNB (gNodeB), and UPF (user plane function).

For a private 5G mobile network deployment, the 5G mobile network core functions are typically implemented as virtual network functions in a cloud platform. Several virtual network functions may be hosted on one or more than one physical computing device (e.g., server blade). Traffic coming from the radio access network (RAN) and external network is processed by a virtual switch implemented in the cloud platform. Often times, the virtual switch is implemented in the same physical computing device as one or more of the virtual network functions.

A virtual switch may process packets using the following steps: (1) continuously poll the configured ingress ports for incoming packets; (2) process incoming packets (e.g., using a packet-processing pipeline such as an OpenFlow pipeline); and (3) send incoming packets to the designated egress ports.

A physical network interface card (pNIC) provides multi-queue support and distributes incoming packets to several processing cores. At the virtual machine (VM), packets are distributed inside the VM into multiple queues. Multi-queue support is introduced to reduce processing latency at the pNIC using receive side scaling (RSS). RSS is a network driver technology that enables the efficient distribution of network receive processing across multiple processing cores in multiprocessor systems. Data of an incoming packet received by the pNIC may be hashed and a particular processing core may be selected based on the least significant bits (LSBs) of the hash value, as provided in the indirection table. As a result, the incoming packet is forwarded to a particular processing core. In a virtual switch, an indirection table may be used to distribute packets coming from ingress ports to available processing cores. The processing cores may perform poll mode driver (PMD) operations to process incoming packets.

In a private network deployment for an industry/factory use case, a single cloud platform may be needed to support various types of network traffic such as enhanced mobile broadband (eMBB) network traffic, critical machine type communication (c-MTC) network traffic, massive machine type communication (m-MTC) network traffic, as well as network traffic between the containerized components of industry control application(s). A virtual switch implemented in the cloud platform may be used to process network traffic between the radio access network (RAN) of the 5G mobile network and the virtualized components of the 5G mobile network core, as well as the network traffic between the application components implemented in the cloud platform. Thus, the virtual switch may become a potential bottleneck for processing network traffic in the cloud platform. Currently, the virtual switch does not differentiate between best-effort network traffic and time-sensitive network traffic (e.g., TSN data streams). Thus, packet processing latency at the virtual switch, which is a key contributor to the overall end-to-end (E2E) latency, cannot be bounded with the current configuration.

Embodiments are disclosed herein that enable deterministic processing latency in a mobile network cloud deployment that is integrated with a time-sensitive network (e.g., a TSN network). Embodiments allow packet processing latency to be reduced at the virtual switching functionality in the cloud. Embodiments enhance may use an enhanced RSS technique to allocate/reserve dedicated processing resources (e.g., processing cores) for processing time-sensitive data streams (e.g., data streams that require deterministic timing characteristics such as TSN data streams) at a virtual switch, which is a core component of the mobile network cloud deployment.

According to some embodiments, a switching instance manager is provided that obtains: 1) traffic characteristics information for relevant time-sensitive data streams that are to traverse a mobile network (e.g., time-sensitive communication assistance information (TSCAI) defined by 3GPP Technical Specifications); 2) tunnel identifiers of tunnels in the mobile network that are to carry the time-sensitive data streams; and 3) application deployment information for an application implemented in the cloud platform. The switching instance manager may then generate configuration information for a virtual switch based on the traffic characteristics information, the tunnel identifiers, and the application deployment information. The configuration information may include information indicating a mapping between the tunnel identifiers and processing cores of the virtual switch and/or information indicating a mapping between communication flows between components of the application and processing cores of the virtual switch. The switching instance manager may then cause the virtual switch to be configured based on the configuration information. The virtual switch may be configured to allocate/reserve certain processing cores of the virtual switch for processing communication flows for which deterministic latency is desired (e.g., for the time-sensitive data streams and/or the communication flows between the application components).

Embodiments provide one or more advantages over existing virtual switching solutions. An advantage provided by various embodiments is that they enable a cloud-based mobile network solution to support features of time-sensitive networks such as time synchronization and time-aware scheduling. In particular, by configuring the virtual switch based on traffic characteristics and tunnel identifiers associated with time-sensitive data streams, the virtual switch is able to allocate/reserve certain processing cores of the virtual switch for processing time-sensitive communication flows. Another advantage provided by various embodiments is that by allocating/reserving certain processing cores of the virtual switch for processing packets tunneled between the RAN and the virtualized UPF, they provide deterministic packet processing latency for such packets. For example, embodiments can be used to provide deterministic processing latency for general packet radio service tunneling protocol (GTP) packets tunneled between the RAN and the UPF in the uplink/downlink directions). Another advantage provided by various embodiments is that by taking into consideration both the traffic characteristics of time-sensitive data streams traversing the mobile network and the application deployment information, they provide a harmonized execution environment for both the a) mobile network virtualized network functions and b) cloudified applications (e.g., industrial applications) that can ensure deterministic packet processing for both the mobile network domain and the application domain. Another advantage provided by various embodiments is that by providing the ability to dynamically configure the virtual switch, as needed (e.g., when new TSN data streams traverse the mobile network and/or a new application is deployed in the cloud platform), they provide a framework for the integrated handling of shared cloud resources (for best-effort services and processing) and dedicated cloud resources (for deterministic services and processing). While certain advantages are mentioned above, those skilled in the art will appreciate that embodiments can provide other technological and practical advantages in view of the present disclosure.

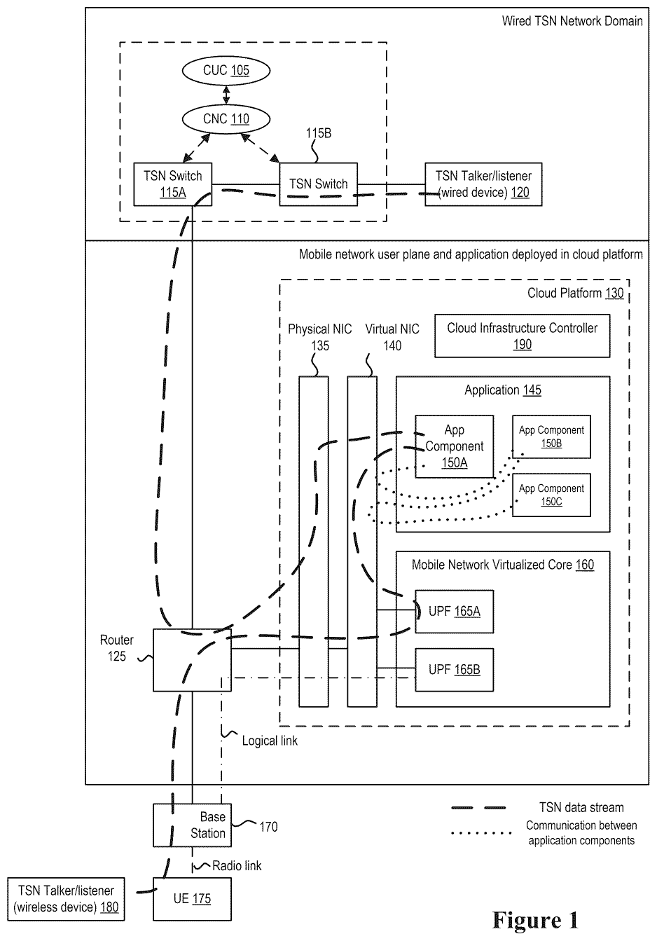

FIG. 1 is a diagram showing an environment that supports time-sensitive communication, according to some embodiments.

As shown in the diagram, the environment includes a CUC 105, a CNC 110, a TSN switch 115A, a TSN switch 115B, and a TSN talker/listener 120 (e.g., a wired end device). The CUC 105, CNC 110, TSN switches 115, and the TSN talker/listener 120 may be part of a wired TSN network domain that provides wired connectivity. The TSN talker/listener 120 may be an end device that participates in time-sensitive communication (e.g., with another end device or an application 145). As used herein, “time-sensitive” communication refers to communication that is to be handled/processed (e.g., by a communication system) with deterministic timing characteristics (e.g., predictable, bounded latency and/or jitter). The CUC 105 may discover end devices, obtain end device capabilities and user requirements, and configure TSN features in end devices. The CNC 110 may define the schedule by which time-sensitive communication (e.g., TSN frames) is transmitted. The CNC 110 may obtain the network topology, network equipment capabilities (e.g., capabilities of TSN bridges), and the end device configuration (e.g., traffic schedules), and may configure the network to ensure proper traffic handling. A TSN switch 115 may perform switching for time-sensitive communication according to a schedule. For purposes of illustration, the diagram shows a TSN architecture and uses TSN terminology. It should be appreciated, however, that embodiments are not limited to the use of TSN, and that other embodiments may use a different type of architecture that supports time-sensitive communication.

As shown in the diagram, the environment further includes a router 125 and a cloud platform 130. The cloud platform 130 may include a physical network interface card (NIC) 135 and a virtual NIC 140. The cloud platform 130 may implement an application 145 and a mobile network virtualized core 160. The application 145 may be composed of multiple components such as application component 150A, application component 150B, and application component 150C. In an embodiment, the application 145 is an industrial control application for controlling end devices (e.g., for controlling factory robots). The mobile network virtualized core 160 may include one or more UPFs 165 such as UPF 165A and UPF 165B. In an embodiment, the mobile network virtualized core 160 is a virtualized implementation of a 5G mobile network core. The router 125 and the cloud platform 130 may collectively implement a mobile network user plane and an application.

As shown in the diagram, the environment further includes a TSN talker/listener 180 (e.g., a wireless end device), a UE 175, and a base station 170. The UE 175 may be any type of device that can wirelessly connect to the base station 170 (e.g., over a radio link) to communicate over the mobile network. For example, the UE 175 may be a smartphone, a tablet, a laptop computer, a desktop computer, or similar device. The base station 170 may be any type of device that facilitates wireless communication between the UE 175 and the mobile network core. For example, the base station 170 may be an eNodeB or a gNodeB. The base station 170 may connect to one or more UPFs 165 over a logical link.

Application components 150 may communicate with TSN talker/listeners. This communication may be time-sensitive (e.g., requires deterministic or bounded latency). For example, as shown in the diagram, application component 150A may communicate with TSN talker/listener 120 using a TSN data stream. Also, as shown in the diagram, application component 150A may communicate with TSN talker/listener 180 using another TSN data stream. Notably, this TSN data stream traverses components of the mobile network such as UPF 165A and base station 170 to reach the TSN talker/listener 180. The mobile network may act as a virtual bridge of the TSN network to provide wireless connectivity. In an embodiment, the TSN network is integrated with the mobile network using the concepts described by 3GPP Technical Specifications (e.g., 3GPP TS 23.501). The integration of the TSN network with the mobile network allows the application 145 to communicate with both wired end devices (e.g., TSN talker/listener 120) and wireless end devices (e.g., TSN talker/listener 180).

Also, as shown in the diagram, application components 150 may communicate with each other as part of providing application functionality. For example, as shown in the diagram, application component 150A may communicate with application component 150B and application component 150B may communicate with application component 150C.

A virtual switch implemented in the cloud platform 130 may provide the virtual NIC 140 and provide switching functionality for the TSN data streams in the cloud platform 130 and communication flows between the application components 150.

In the future, it is envisioned that private mobile networks (e.g., private 5G mobile networks) will need to support a wide range of communication services from enhanced mobile broadband (eMBB), where the objective is to enhance capacity, to critical machine type communication (c-MTC), which has strict latency requirements. For example, in a smart manufacturing scenario, a single private mobile network may need to support motion control and mobile robot network traffic, mobile broadband network traffic for employees working on the shop floor, and video network traffic for a guidance control system.

A challenge that arises in this type of deployment is how to support deterministic latency for communication between the base station 170 and the virtualized network functions (e.g., UPFs 165) and communication between the virtualized application components 150 that are implemented in the same cloud platform 130.

The mobile network may establish one or more tunnels (e.g., between the base station 170 and UPFs 165) to carry TSN data streams. For example, the mobile network may establish a protocol data unit (PDU) session for each TSN data stream (there may be a one-to-one mapping between PDU session and TSN data streams) and establish a GTP-U tunnel for each PDU session. A GTP-U tunnel may be identified using a tunnel endpoint identifier (TEID).

According to 3GPP Technical Specifications (e.g., 3GPP TS 29.281), GTP-U tunnels are used to encapsulate transport PDUs (T-PDUs. T-PDU may be a user data packet (e.g., an internet protocol (IP) datagram) that is sent between a UE and network entity in an external packet data network, and it is also a payload of a tunnel using GTP-U (GTP user plane). The inner IP packet in a GTPv1-U (GTP version 1 user plane) packet is either an IP packet sent to a UE in downlink direction over one or more tunnels from the external network or an IP packet sent from UE in the uplink direction over one or more tunnels to the external network identified by an access point name (APN). Network traffic sent between the router 125 and the physical NIC 135 may be in the form of GTP packets transported over User Datagram Protocol (UDP). A TEID may be used to differentiate network traffic for different UEs. A TEID may identify a tunnel endpoint in the receiving GTP-U protocol entity for a given pair of UDP/IP end points (e.g., UE 175 and UPF 165). TEIDs may be exchanged between tunnel endpoints using control plane messaging.

As shown in the diagram, the cloud platform 130 includes a cloud infrastructure controller 190. As will be described in additional detail herein, in an embodiment, the cloud infrastructure controller 190 obtains traffic characteristics information for one or more time-sensitive data streams (e.g., TSN data streams) that are to traverse the mobile network and the tunnel identifiers of tunnels (e.g., TEIDs of GTP-U tunnels) in the mobile network that are to carry the one or more time-sensitive data streams. The cloud infrastructure controller may also obtain application deployment information for the application 145 implemented in the cloud platform 130. The cloud infrastructure controller 190 may then generate configuration information for the virtual switch based on the tunnel identifiers, the traffic characteristics information for the one or more time-sensitive data streams, and the application deployment information for the application. The configuration information may include information indicating a mapping between the tunnel identifiers and processing cores of the virtual switch and/or information indicating a mapping between communication flows between application components 150 and processing cores of the virtual switch. The cloud infrastructure controller 190 may then cause the virtual switch to be configured based on the configuration information. The virtual switch may be configured to allocate/reserve certain processing cores of the virtual switch for processing certain communication flows (e.g., the TSN data streams and/or the communication flows between the application components 150).

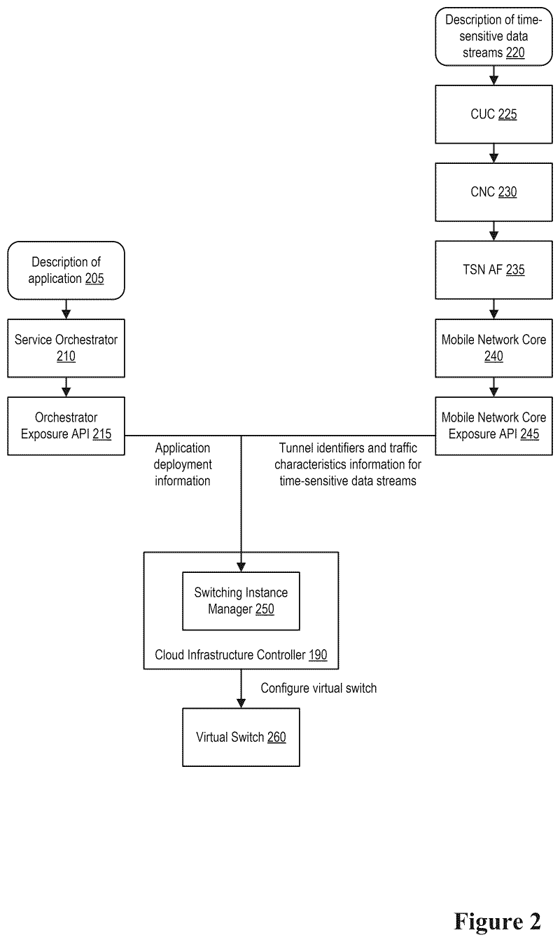

FIG. 2 is a diagram showing a switching instance manager configuring a virtual switch, according to some embodiments.

As shown in the diagram, a description of the application 205 is provided to the service orchestrator 210. The service orchestrator 210 may be responsible for deploying applications in the cloud platform 130 (e.g., placing applications on particular server devices and allocating resources to the applications). The service orchestrator 210 may generate application deployment information based on the description 205 and expose the application deployment information to a cloud infrastructure controller 190 via an orchestrator exposure API 215. In an embodiment, the application deployment information includes information regarding one or more of: resources used by the components of the application, scheduling of resources for components of the application, service requirements of the application (e.g., latency requirements between application components), and timing of network traffic associated with the application (e.g., when an application component will send network traffic and the jitter associated with that network traffic).

Also, as shown in the diagram, a description of time-sensitive data streams 220 (e.g., TSN data streams) may be provided to a CUC 225 of the TSN network. The CUC 225 may provide the description 220 to a CNC 230 of the TSN network, which in turn may provide the description 220 to a TSN application function (AF) 235. The TSN AF 235 may generate traffic characteristics information for time-sensitive data streams based on the description 220 (in a format that is understandable by the mobile network). The TSN AF 235 may then provide the traffic characteristics information to the mobile network core 240. The mobile network core 240 may expose the tunnel identifiers of the tunnels in the mobile network that are to carry the time-sensitive data streams and the traffic characteristics information to the cloud infrastructure controller 190 via a mobile network core exposure API 245. In an embodiment, the tunnel identifiers are GTP tunnel endpoint identifiers.

In an embodiment, the traffic characteristics information includes TSCAI (e.g., as defined by 3GPP Technical Standards (e.g., 3GPP TS 23.501). TSCAI describes the traffic characteristics for time-sensitive data streams for use in the 5G mobile network. TSCAI may include information regarding one or more of: flow direction, periodicity, burst arrival time, survival time, burst arrival time window, burst size, and capability for burst arrival time adaptation. Currently, TSCAI is used by the 5G mobile network RAN to allow more efficient scheduling of QoS flows that have periodic and/or deterministic traffic characteristics. However, using the techniques disclosed herein, the TSCAI can be used by the cloud infrastructure controller 190 to configure the virtual switch 260.

As shown in the diagram, a switching instance manager 250 of the cloud infrastructure controller 190 may obtain the application deployment information via the orchestrator exposure API 215. Also, the switching instance manager 250 may obtain the tunnel identifiers and traffic characteristics information for time-sensitive data streams via the mobile network core exposure API 245. The switching instance manager 250 may generate configuration information based on the application deployment information, the tunnel identifiers, and the traffic characteristics information for time-sensitive data streams. The configuration information may include information associated with a mapping between communication flows and processing cores of the virtual switch. For example, the configuration information may include information indicating a mapping between TSN data streams that are to traverse the mobile network and processing cores of the virtual switch (e.g., a mapping between PDU sessions established for TSN data streams and processing cores) and/or information indicating a mapping between communication flows between application components and processing cores of the virtual switch. The switching instance manager 250 may then cause the virtual switch 260 to be configured based on the configuration information. The virtual switch 260 may be configured to allocate/reserve certain processing cores of the virtual switch for processing certain communication flows (e.g., the TSN data streams and/or the communication flows between the application components).

By allocating/reserving processing cores at the virtual switch 260 in this way, embodiments allow the processing of certain communication flows (e.g., TSN data streams and/or communication flows between application components) to be prioritized at the virtual switch 260 over other types of communication flows (e.g., “best-effort” communication flows). Also, embodiments allow packet processing resources for different communication flows to be allocated/reserved at the virtual switch 260 in a harmonized way (e.g., such that the different communication flows do not have to compete for the same resources).

In an embodiment, during operation, the switching instance manager 250 continuously or periodically polls the status of the mobile network domain and/or the application domain. If the switching instance manager 250 determines that a new TSN data stream is traversing the mobile network and/or a new application or application component is deployed in the cloud platform, the switching instance manager 250 may obtain updated traffic characteristics information and/or updated application deployment information, and generate updated configuration information for the virtual switch 260 based on the updated information, as needed. Similarly, if a TSN data stream traversing the mobile network is terminated and/or an application or application component is terminated in the cloud platform, the switching instance manager 250 may generate updated configuration information for the virtual switch 260 to take the updated status into account.

In an embodiment, the switching instance manager 250 causes the virtual switch 260 to be configured by providing configuration instructions to the virtual switch 260. The configuration instructions may cause the virtual switch 260 to generate/update its indirection table. The virtual switch 260 may generate/update its indirection able by generating hash values based on the TEIDs (e.g., by applying a hash function to the TEIDs) and mapping the hash values to particular processing cores of the virtual switch 260.

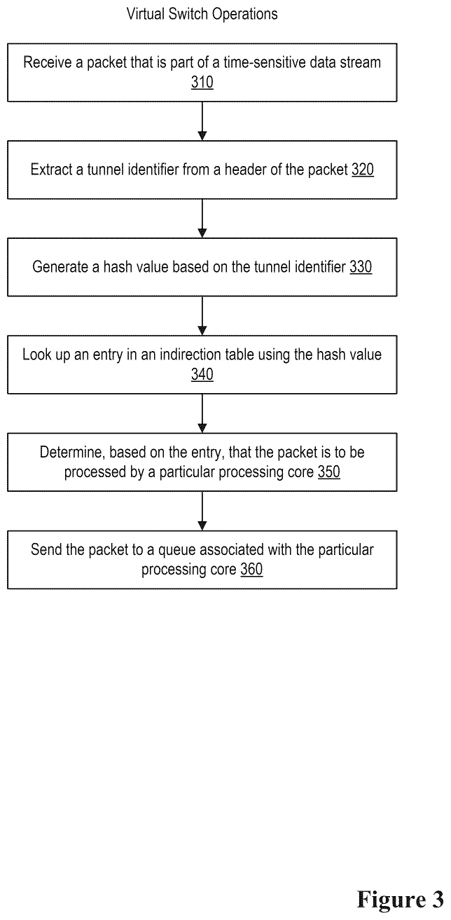

FIG. 3 is a flow diagram showing a method performed by a virtual switch to process a packet traversing a mobile network, according to some embodiments.

At operation 310, the virtual switch receives a packet that is part of a time-sensitive data stream. For example, virtual switch 260 could receive a packet that is part of a TSN data stream traversing the mobile network.

At operation 320, the virtual switch extracts a tunnel identifier from a header of the packet. For example, the virtual switch could extract a TEID from a GTP header of the packet. The tunnel identifier identifies the tunnel that is being used to carry the packet.

At operation 330, the virtual switch generates a hash value based on the tunnel identifier. For example, the virtual switch could generate a hash value by applying a hash function to the tunnel identifier. In some embodiments, the hash function is a XOR hash function or a Toeplitz hash function, but those skilled in the art will recognize that other types of hash functions can be used.

At operation 340, the virtual switch looks up an entry in the indirection table using the hash value. The entry indicates a mapping between the hash value and a particular processing core of the virtual switch. For example, the entry may include a first field that includes the hash value and a second field that includes an identifier of the particular processing core.

At operation 350, the virtual switch determines, based on the entry, that the packet is to be forwarded to the particular processing core. For example, the virtual switch may determine that the packet is to be forwarded to the particular processing core because the entry includes the identifier of the particular processing core.

At operation 360, the virtual switch sends the packet to a queue associated with the particular processing core. Each processing core of the virtual switch may be associated with a queue from which the processing core pulls packets from. Sending the packet to the queue associated with the particular processing core causes the packet to be processed by the particular processing core.

In an embodiment, the virtual switch obtains configuration instructions from a cloud infrastructure controller and configures the indirection table to indicate mappings between hash values and processing cores of the virtual switch based on the configuration instructions.

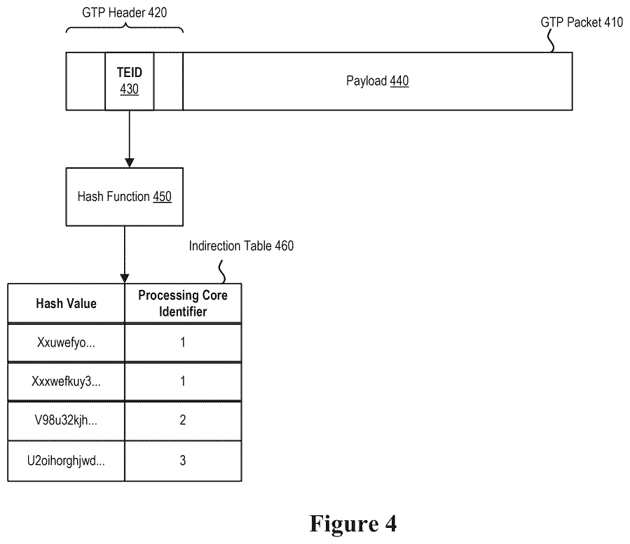

FIG. 4 is a diagram showing the use of an indirection table to process a packet, according to some embodiments.

As shown in the diagram, an indirection table 460 may include multiple entries. Each entry may include a hash value (in the “Hash Value” field) and an identifier of a processing core (in the “Processing Core Identifier” field). For example, in the example shown in the diagram, the first entry of the indirection table 460 includes a hash value of “Xxuwefyo . . . ” and a processing core identifier of “1”. This entry indicates that the hash value “”“Xxuwefyo . . . ” is mapped to the processing core associated with identifier “1”. The other entries of the indirection table may be interpreted in a similar manner and thus are not further described herein for the sake of conciseness.

Also, as shown in the diagram, a GTP packet 410 may include a GTP header 420 and a payload 440. The GTP header may include a TEID 430.

When a virtual switch receives the GTP packet 410, it may generate a hash value based on applying a hash function 450 to the TEID 430 included in the GTP header 420 of the GTP packet 410. The virtual switch may look up an entry in the indirection table 460 using the hash value (e.g., look for an entry that has a matching hash value in the “Hash Value” field). The virtual switch may select a processing core that is to process the GTP packet 410 based on the entry (e.g., based on the processing core identifier included in the “Processing Core Identifier” field of the entry). The virtual switch may then send the GTP packet 410 to the queue associated with the selected processing core.

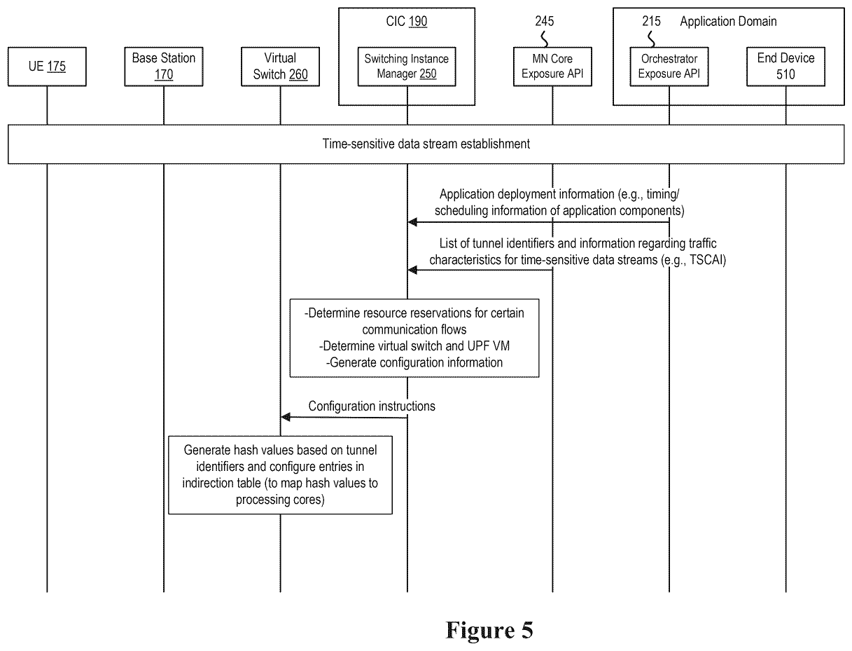

FIG. 5 is a diagram showing component interactions to configure a virtual switch, according to some embodiments.

As shown in the diagram, a time-sensitive data stream to/from an end device 510 may be established that traverses a mobile network (e.g., that traverses UE 175 and base station 170). The switching instance manager 250 of the cloud infrastructure controller 190 may obtain application deployment information for an application via the orchestrator exposure API 215. The application deployment information may include, for example, information regarding one or more of: resources used by the components of the application, scheduling of resources for components of the application, service requirements of the application, and timing of network traffic associated with the application.

Also, the switching instance manager 250 may obtain a list of tunnel identifiers (of tunnels in the mobile network carrying time-sensitive data streams) and information regarding traffic characteristics for time-sensitive data streams via the mobile network core exposure API 245. The tunnel identifiers may be TEIDs of GTP tunnels in the mobile network. The traffic characteristics information may include, for example, information regarding one or more of: flow direction, periodicity, burst arrival time, survival time, burst arrival time window, burst size, and capability for burst arrival time adaptation.

The switching instance manager 250 may determine resource reservations for certain communication flows (e.g., the number of processing cores to reserve for time-sensitive data streams and/or communication flows between application components), determine the virtual switches and mobile network virtualized UPFs that are to process the communication flows, and generate configuration information. In the example shown in the diagram, the switching instance manager 250 determines that virtual switch 260 is to process a time-sensitive data stream and/or a communication flow between application components, and thus may generate configuration information for virtual switch 260. The switching instance manager 250 may generate configuration instructions based on the configuration information and provide the configuration instructions to the virtual switch 260.

The virtual switch 260 may apply the configuration instructions, which may involve generating hash values based on the tunnel identifiers and configuring entries in the indirection table to map the hash values to processing cores of the virtual switch 260 (to map the TSN data streams to processing cores).

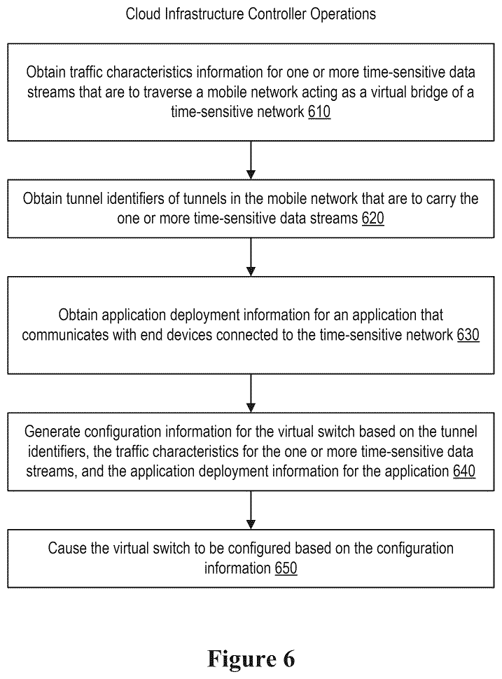

FIG. 6 is a flow diagram showing a method for configuring a virtual switch implemented in a cloud platform, according to some embodiments. In an embodiment, the method may be performed by one or more network devices (e.g., implementing a switching instance manager 250 of a cloud infrastructure controller 190).

The operations in the flow diagrams are described with reference to the exemplary embodiments of the other figures. However, it should be understood that the operations of the flow diagrams can be performed by embodiments other than those discussed with reference to the other figures, and embodiments discussed with reference to these other figures can perform operations different than those discussed with reference to the flow diagrams. Although shown in a particular order, in some embodiments, the operations shown in the diagram (and the operations shown in the other diagrams) may be performed in a different order.

At operation 610, the one or more network devices obtain traffic characteristics information for one or more time-sensitive data streams that are to traverse a mobile network acting as a virtual bridge of a time-sensitive network. One or more components of the mobile network, such as one or more UPFs are implemented in the cloud platform. In an embodiment, the time-sensitive data streams are TSN data streams. In an embodiment, the traffic characteristics information for the one or more time-sensitive data streams includes information regarding one or more of: flow direction, periodicity, burst arrival time, survival time, burst arrival time window, burst size, and capability for burst arrival time adaptation.

At operation 620, the one or more network devices obtain tunnel identifiers of tunnels in the mobile network that are to carry the one or more time-sensitive data streams. In some embodiments, the tunnels in the mobile network are GTP tunnels and the tunnel identifiers are TEIDs. In some embodiments, the traffic characteristics information for the one or more time-sensitive data streams and/or the tunnel identifiers are obtained via an API exposed by the mobile network.

At operation 630, the one or more network devices obtain application deployment information for an application that communicates with end devices connected to the time-sensitive network. In some embodiments, one or more components of the application are implemented in the cloud platform. In some embodiments, the application deployment information for the application includes information regarding one or more of: resources used by one or more components of the application, scheduling of resources for one or more components of the application, service requirements of the application, and timing of network traffic associated with the application. In some embodiments, the application deployment information for the application is obtained via an application programming interface (API) exposed by a service orchestrator of the cloud platform.

At operation 640, the one or more network devices generate configuration information for the virtual switch based on the tunnel identifiers, the traffic characteristics information for the one or more time-sensitive data streams, and the application deployment information for the application. In some embodiments, the configuration information includes information associated with a mapping between one or more communication flows and one or more processing cores of the virtual switch. In some embodiments, the information associated with the mapping includes one or more of: (1) information indicating a mapping between the tunnel identifiers of the tunnels in the mobile network that are to carry the one or more time-sensitive data streams and one or more processing cores of the virtual switch and (2) information indicating a mapping between communication flows between components of the application and one or more processing cores of the virtual switch.

At operation 650, the one or more network devices cause the virtual switch to be configured based on the configuration information. In some embodiments, the one or more network devices generate configuration instructions based on the configuration information. The one or more network devices provide the generated configuration instructions to the virtual switch. In some embodiments, the virtual switch is configured to generate or update an indirection table (e.g., with entries that indicate mappings between hash values of tunnel identifiers and processing cores of the virtual switch) based on the configuration instructions.

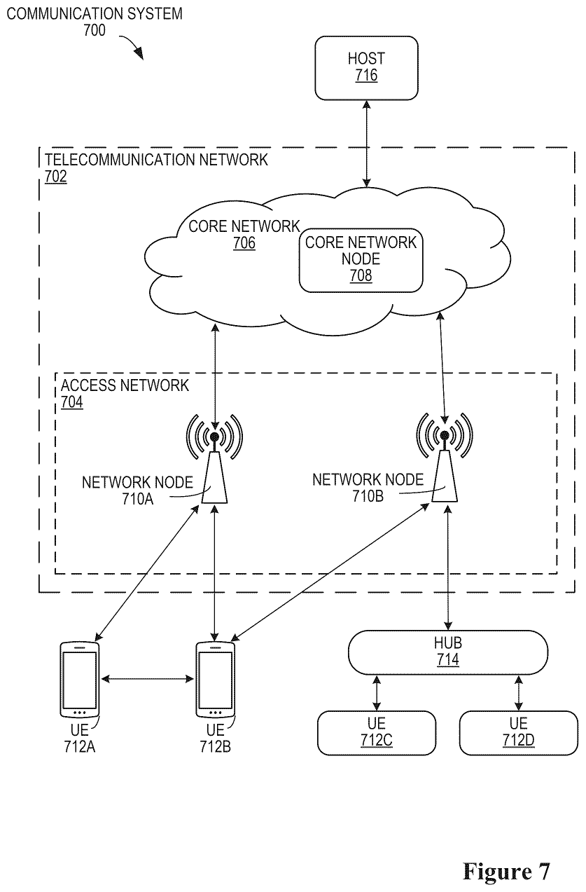

FIG. 7 shows an example of a communication system, according to some embodiments.

In the example, the communication system 700 includes a telecommunication network 702 that includes an access network 704, such as a radio access network (RAN), and a core network 706, which includes one or more core network nodes 708. As discussed herein above, in an embodiment, one or more of the core network nodes 708 may be implemented in a cloud platform (as virtualized network functions). The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

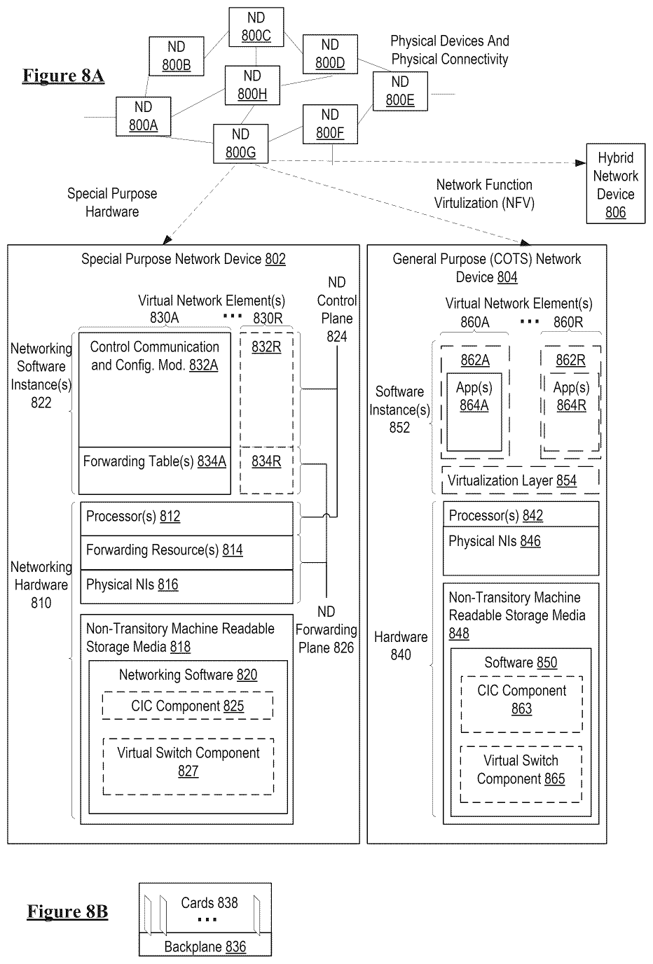

FIG. 8A illustrates connectivity between network devices (NDs) within an exemplary network, as well as three exemplary implementations of the NDs, according to some embodiments of the invention. FIG. 8A shows NDs 800A-H, and their connectivity by way of lines between 800A-800B, 800B-800C, 800C-800D, 800D-800E, 800E-800F, 800F-800G, and 800A-800G, as well as between 800H and each of 800A, 800C, 800D, and 800G. These NDs are physical devices, and the connectivity between these NDs can be wireless or wired (often referred to as a link). An additional line extending from NDs 800A, 800E, and 800F illustrates that these NDs act as ingress and egress points for the network (and thus, these NDs are sometimes referred to as edge NDs; while the other NDs may be called core NDs).

Two of the exemplary ND implementations in FIG. 8A are: 1) a special-purpose network device 802 that uses custom application-specific integrated-circuits (ASICs) and a special-purpose operating system (OS); and 2) a general purpose network device 804 that uses common off-the-shelf (COTS) processors and a standard OS.

The special-purpose network device 802 includes networking hardware 810 comprising a set of one or more processor(s) 812, forwarding resource(s) 814 (which typically include one or more ASICs and/or network processors), and physical network interfaces (NIs) 816 (through which network connections are made, such as those shown by the connectivity between NDs 800A-H), as well as non-transitory machine readable storage media 818 having stored therein networking software 820. During operation, the networking software 820 may be executed by the networking hardware 810 to instantiate a set of one or more networking software instance(s) 822. Each of the networking software instance(s) 822, and that part of the networking hardware 810 that executes that network software instance (be it hardware dedicated to that networking software instance and/or time slices of hardware temporally shared by that networking software instance with others of the networking software instance(s) 822), form a separate virtual network element 830A-R. Each of the virtual network element(s) (VNEs) 830A-R includes a control communication and configuration module 832A-R (sometimes referred to as a local control module or control communication module) and forwarding table(s) 834A-R, such that a given virtual network element (e.g., 830A) includes the control communication and configuration module (e.g., 832A), a set of one or more forwarding table(s) (e.g., 834A), and that portion of the networking hardware 810 that executes the virtual network element (e.g., 830A).

In an embodiment, software 820 includes code such as cloud infrastructure controller (CIC) component 825, which when executed by networking hardware 810, causes the special-purpose network device 802 to perform operations of one or more embodiments disclosed herein as part of networking software instances 822 (e.g., operations to configure a virtual switch). In an embodiment, software 820 includes code such as virtual switch component 827, which when executed by networking hardware 810, causes the special-purpose network device 802 to perform operations of one or more embodiments disclosed herein as part of networking software instances 822 (e.g., operations to provide switching functionality for communication flows).

The special-purpose network device 802 is often physically and/or logically considered to include: 1) a ND control plane 824 (sometimes referred to as a control plane) comprising the processor(s) 812 that execute the control communication and configuration module(s) 832A-R; and 2) a ND forwarding plane 826 (sometimes referred to as a forwarding plane, a data plane, or a media plane) comprising the forwarding resource(s) 814 that utilize the forwarding table(s) 834A-R and the physical NIs 816. By way of example, where the ND is a router (or is implementing routing functionality), the ND control plane 824 (the processor(s) 812 executing the control communication and configuration module(s) 832A-R) is typically responsible for participating in controlling how data (e.g., packets) is to be routed (e.g., the next hop for the data and the outgoing physical NI for that data) and storing that routing information in the forwarding table(s) 834A-R, and the ND forwarding plane 826 is responsible for receiving that data on the physical NIs 816 and forwarding that data out the appropriate ones of the physical NIs 816 based on the forwarding table(s) 834A-R.

FIG. 8B illustrates an exemplary way to implement the special-purpose network device 802 according to some embodiments of the invention. FIG. 8B shows a special-purpose network device including cards 838 (typically hot pluggable). While in some embodiments the cards 838 are of two types (one or more that operate as the ND forwarding plane 826 (sometimes called line cards), and one or more that operate to implement the ND control plane 824 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL) / Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 836 (e.g., a first full mesh coupling the line cards and a second full mesh coupling all of the cards).

Returning to FIG. 8A, the general purpose network device 804 includes hardware 840 comprising a set of one or more processor(s) 842 (which are often COTS processors) and physical NIs 846, as well as non-transitory machine readable storage media 848 having stored therein software 850. During operation, the processor(s) 842 execute the software 850 to instantiate one or more sets of one or more applications 864A-R. While one embodiment does not implement virtualization, alternative embodiments may use different forms of virtualization. For example, in one such alternative embodiment the virtualization layer 854 represents the kernel of an operating system (or a shim executing on a base operating system) that allows for the creation of multiple instances 862A-R called software containers that may each be used to execute one (or more) of the sets of applications 864A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 854 represents a hypervisor (sometimes referred to as a virtual machine monitor (VMM)) or a hypervisor executing on top of a host operating system, and each of the sets of applications 864A-R is run on top of a guest operating system within an instance 862A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels and sets of applications that are run in different software containers).

The instantiation of the one or more sets of one or more applications 864A-R, as well as virtualization if implemented, are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared), forms a separate virtual network element(s) 860A-R.

The virtual network element(s) 860A-R perform similar functionality to the virtual network element(s) 830A-R-e.g., similar to the control communication and configuration module(s) 832A and forwarding table(s) 834A (this virtualization of the hardware 840 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 862A-R corresponding to one VNE 860A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 862A-R to VNEs also apply to embodiments where such a finer level of granularity and/or unikernels are used.

In certain embodiments, the virtualization layer 854 includes a virtual switch that provides similar forwarding services as a physical Ethernet switch. Specifically, this virtual switch forwards traffic between instances 862A-R and the physical NI(s) 846, as well as optionally between the instances 862A-R; in addition, this virtual switch may enforce network isolation between the VNEs 860A-R that by policy are not permitted to communicate with each other (e.g., by honoring virtual local area networks (VLANs)).

In an embodiment, software 850 includes code such as cloud infrastructure controller (CIC) component 863, which when executed by processor(s) 842, causes the general purpose network device 804 to perform operations of one or more embodiments described herein as part of software instances 862A-R (e.g., operations to configure a virtual switch). In an embodiment, software 850 includes code such as virtual switch component 865, which when executed by processor(s) 842, causes the general purpose network device 804 to perform operations of one or more embodiments described herein as part of software instances 862A-R (e.g., operations to provide switching functionality for communication flows).

The third exemplary ND implementation in FIG. 8A is a hybrid network device 806, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 802) could provide for para-virtualization to the networking hardware present in the hybrid network device 806.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 830A-R, VNEs 860A-R, and those in the hybrid network device 806) receives data on the physical NIs (e.g., 816, 846) and forwards that data out the appropriate ones of the physical NIs (e.g., 816, 846). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method performed by one or more network devices to configure a virtual switch implemented in a cloud platform, the method comprising:
obtaining traffic characteristics information for one or more time-sensitive data streams that are to traverse a mobile network acting as a virtual bridge of a time-sensitive network, wherein one or more components of the mobile network are implemented in the cloud platform;
obtaining tunnel identifiers of tunnels in the mobile network that are to carry the one or more time-sensitive data streams;
obtaining application deployment information for an application that communicates with end devices connected to the time-sensitive network, wherein one or more components of the application are implemented in the cloud platform;
generating configuration information for the virtual switch based on the tunnel identifiers, the traffic characteristics information for the one or more time-sensitive data streams, and the application deployment information for the application; and
causing the virtual switch to be configured based on the configuration information.

2. The method of claim 1, wherein the traffic characteristics information for the one or more time-sensitive data streams includes information regarding one or more of: flow direction, periodicity, burst arrival time, survival time, burst arrival time window, burst size, and capability for burst arrival time adaptation.

3. The method of claim 1, wherein the application deployment information for the application includes information regarding one or more of: resources used by the one or more components of the application, scheduling of resources for the one or more components of the application, service requirements of the application, and timing of network traffic associated with the application.

4. The method of claim 1, wherein the traffic characteristics information for the one or more time-sensitive data streams is obtained via an application programming interface (API) exposed by the mobile network.

5. The method of claim 1, wherein the application deployment information for the application is obtained via an application programming interface (API) exposed by a service orchestrator of the cloud platform.

6. The method of claim 1, wherein the configuration information includes information associated with a mapping between communication flows and processing cores of the virtual switch.

7. The method of claim 6, wherein the information regarding the mapping includes one or more of: (1) information indicating a mapping between the tunnel identifiers of the tunnels in the mobile network that are to carry the one or more time-sensitive data streams and one or more processing cores of the virtual switch and (2) information indicating a mapping between communication flows between the one or more components of the application and the one or more processing cores of the virtual switch.

8. The method of claim 6, wherein the virtual switch is configured to generate or update an indirection table.

9. The method of claim 1, wherein the tunnels in the mobile network are general packet radio service tunneling protocol (GTP) tunnels and the tunnel identifiers are tunnel endpoint identifiers (TEIDs).

10. The method of claim 1, wherein the time-sensitive data streams are time-sensitive networking (TSN) data streams.

11. A method performed by one or more network devices implementing a virtual switch in a cloud platform, the method comprising:
receiving, by the virtual switch, a packet traversing a mobile network implemented in the cloud platform and acting as a virtual bridge of a time-sensitive network, wherein the packet is part of a time-sensitive data stream;
extracting, by the virtual switch, a tunnel identifier from a header of the packet;
generating, by the virtual switch, a hash value based on the tunnel identifier;
looking up, by the virtual switch, an entry in an indirection table using the hash value, wherein the entry indicates a mapping between the hash value and a particular processing core of the virtual switch;
determining, by the virtual switch based on the entry, that the packet is to be processed by the particular processing core; and
sending, by the virtual switch, the packet to a queue associated with the particular processing core.

12. The method of claim 11, wherein the tunnel identifier is a tunnel endpoint identifier (TEID) and the header of the packet is a general packet radio service (GPRS) tunneling protocol (GTP) header.

13. The method of claim 11, wherein the time-sensitive data stream is a time-sensitive networking (TSN) data stream.

14. The method of claim 11, further comprising:
obtaining, by the virtual switch, configuration instructions from a cloud infrastructure controller; and
configuring, by the virtual switch, an indirection table to indicate mappings between hash values and processing cores of the virtual switch based on the configuration instructions.

15. A non-transitory machine-readable storage medium that provides instructions that, if executed by a processor of one or more network devices, will cause the one or more network devices to carry out a method comprising steps of:
obtaining traffic characteristics information for one or more time-sensitive data streams that are to traverse a mobile network acting as a virtual bridge of a time-sensitive network, wherein one or more components of the mobile network are implemented in the cloud platform;
obtaining tunnel identifiers of tunnels in the mobile network that are to carry the one or more time-sensitive data streams;
obtaining application deployment information for an application that communicates with end devices connected to the time-sensitive network, wherein one or more components of the application are implemented in the cloud platform;
generating configuration information for the virtual switch based on the tunnel identifiers, the traffic characteristics information for the one or more time-sensitive data streams, and the application deployment information for the application; and
causing the virtual switch to be configured based on the configuration information.

16. A network device comprising:
one or more processors; and
a non-transitory machine-readable storage medium storing instructions therein that when executed by the one or more processors causes the network device to carry out a method comprising steps of:
obtaining traffic characteristics information for one or more time-sensitive data streams that are to traverse a mobile network acting as a virtual bridge of a time-sensitive network, wherein one or more components of the mobile network are implemented in the cloud platform;
obtaining tunnel identifiers of tunnels in the mobile network that are to carry the one or more time-sensitive data streams;
obtaining application deployment information for an application that communicates with end devices connected to the time-sensitive network, wherein one or more components of the application are implemented in the cloud platform;
generating configuration information for the virtual switch based on the tunnel identifiers, the traffic characteristics information for the one or more time-sensitive data streams, and the application deployment information for the application; and
causing the virtual switch to be configured based on the configuration information. ***
